(19) United States
(12) Patent Application Publication
(10) Pub. No.: US 2010/0149264 A1
(43) Pub. Date: Jun. 17, 2010

(54) Liquid Ejecting Head, Liquid Ejecting Head Unit, and Liquid Ejecting Apparatus

(75) Inventors: Isao TAKIMOTO, Nagano-ken (JP); Toru NAGATE, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/607,728

(22) Filed: Oct. 28, 2009

(30) Foreign Application Priority Data
Dec. 15, 2008 (JP) 2008-318009

(51) Int. Cl. B41J 2/14

(52) U.S. Cl. 347/47

(57) ABSTRACT

A liquid ejecting head includes a nozzle plate that has a transparent property and includes a nozzle row in which a plurality of nozzle openings ejecting liquids are arranged in line, and a communicating path forming substrate that is bonded to the nozzle plate and has a communicating path communicating with the nozzle openings, wherein on a surface of one of the communicating path forming substrate and the nozzle plate bonded to a surface of the other thereof, a mark for identifying a nozzle opening as a reference for positioning is formed in the vicinity of the nozzle opening as a reference for positioning among the nozzle openings.

### BACKGROUND

1. Technical Field

The present invention relates to a liquid ejecting head, a liquid ejecting head unit, and a liquid ejecting apparatus.

2. Related Art

A liquid ejecting apparatus represented by an ink jet recording apparatus such as an ink jet printer includes a plurality of liquid ejecting heads ejecting liquids such as an ink. The plurality of liquid ejecting heads are required to be positioned (aligned) with high accuracy in order to cause such liquid ejecting apparatus to print (apply liquids) with high accuracy.

As a method of aligning a plurality of liquid ejecting heads, a following method is known (for example, see JP-A-2004-322606, FIGS. 3 and 5). That is, the plurality of liquid ejecting heads are opposed to a base plate provided with alignment marks and the liquid ejecting heads are observed through a transparent base plate by an imaging unit so that the liquid ejecting heads are aligned by positioning a nozzle opening of each liquid ejecting head and an alignment mark. JP-A-2004-322606 (FIG. 3 and FIG. 5) also describes a method in which nozzle marks are formed on a surface of a nozzle plate so that the liquid ejecting heads are aligned with the nozzle marks and fixed to a holding member.

There is an advantage that the positioning accuracy can be improved when the liquid ejecting heads are aligned by using nozzle openings which actually discharge liquids, as described above. However, since the liquid ejecting heads are aligned by using an imaging unit, it is difficult to specify the distance from an end to a nozzle corresponding the nozzle opening other than those at both ends of the nozzle row. Therefore, it is difficult to identify which nozzle opening is a reference nozzle opening for positioning and the liquid ejecting heads may not be aligned easily. In the case where the nozzle openings at both ends of the nozzle row are set to be references, the nozzle openings can be specified as those at both ends of the nozzle row by the imaging unit. However, it is not preferable to set the nozzle openings at both ends of the nozzle row as references in order to position the liquid ejecting heads with high accuracy. This is because the nozzle openings at both ends may be dummy nozzles which discharge no inks or the opening positions may be deviated since the surface of a substrate moves over by making holes as nozzle openings through the substrate. In addition, it is not practical to change the shapes of the nozzle openings in order to identify the nozzle openings as a reference for positioning because the ink-discharging characteristics may be changed.

Further, when the nozzle marks are formed on the surface of the nozzle plate, inks adhere to the nozzle mark when wiping the surface of the nozzle plate. Accordingly, an ink-discharging surface may be contaminated.

### SUMMARY

An advantage of some aspects of the invention is a liquid ejecting head which can be aligned more easily with high accuracy, a liquid ejecting head unit including the liquid ejecting head aligned with high accuracy, and a reliable liquid ejecting apparatus having the liquid ejecting head.

A liquid ejecting head according to a first aspect of the invention includes a nozzle plate that has a transparent property and includes a nozzle row in which a plurality of nozzle openings ejecting liquids are arranged in line, and a communicating path forming substrate that is bonded to the nozzle plate and has a communicating path communicating with the nozzle openings. In the liquid ejecting head, on a surface of one of the communicating path forming substrate and the nozzle plate bonded to a surface of the other thereof, a mark for identifying a nozzle opening as a reference for positioning is formed in the vicinity of the nozzle opening as a reference for positioning among the nozzle openings.

In this case, the mark is formed on the surface of one of the nozzle plate and the communicating path forming substrate that are bonded. Accordingly, the mark can be recognized from the nozzle plate side having the transparent property, so that the nozzle opening as a reference for positioning can be easily identified. Therefore, the liquid ejecting head can be easily aligned. Further, any nozzle openings in the nozzle row as well as the nozzle openings at both ends of the nozzle row can be set as a reference for positioning so that the liquid ejecting head can be aligned with high accuracy. It is to be noted that the nozzle plate having the transparent property according to the aspect of the invention refers to nozzle plates having a transparent property at least to the extent that the mark formed can be recognized from the nozzle plate side.

It is preferable that the mark is a recess formed on the surface of the communicating path forming substrate bonded to the surface of the nozzle plate. The recess formed on the surface of the communicating path forming substrate bonded to the surface of the nozzle plate can be easily formed, does not affect the liquid discharging characteristics, and is easily recognized, so that the liquid ejecting head can be easily aligned.

The liquid ejecting head unit according to a second aspect of the invention includes the plurality of liquid ejecting heads, and a fixing member that positions and fixes the liquid ejecting heads with reference to the nozzle opening as a reference for positioning that is identified by the mark from the nozzle plate side. The liquid ejecting head unit is positioned with high accuracy by including the liquid ejecting heads. Therefore, the liquid ejecting head unit according to the aspect of the invention has high reliability.

A liquid ejecting apparatus according to a third aspect of the invention includes the liquid ejecting head unit. The liquid ejecting head apparatus according to the aspect of the invention has high reliability by including the liquid ejecting head unit which includes the liquid ejecting heads aligned with high accuracy.

### BRIEF DESCRIPTION OF THE DRAWINGS

The invention will be described with reference to the accompanying drawings, wherein like numbers reference like elements.

FIG. 1 is an exploded perspective view of a head main body according to an embodiment.

FIG. 2 is a cross-sectional view of the head main body according to the embodiment.

FIG. 3 is a schematic bottom view of the head main body according to the embodiment.

FIGS. 4A and 4B are diagrams illustrating an alignment method.

FIG. 5 is a diagram illustrating the alignment method.

FIG. 6 is a schematic perspective view illustrating an ink jet recording head unit according to the embodiment.

FIG. 7 is a schematic perspective view of an ink jet recording apparatus according to the embodiment.

### DESCRIPTION OF EXEMPLARY EMBODIMENTS

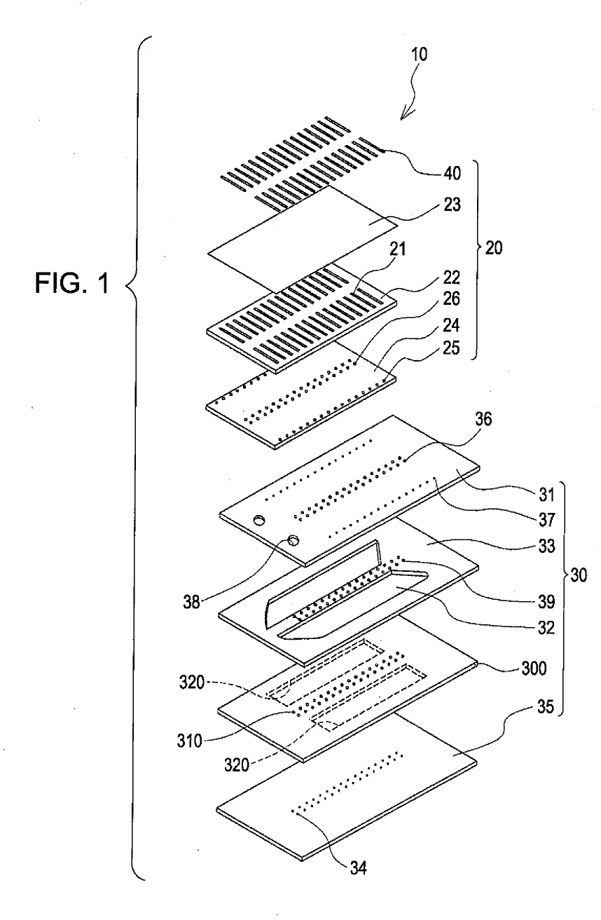

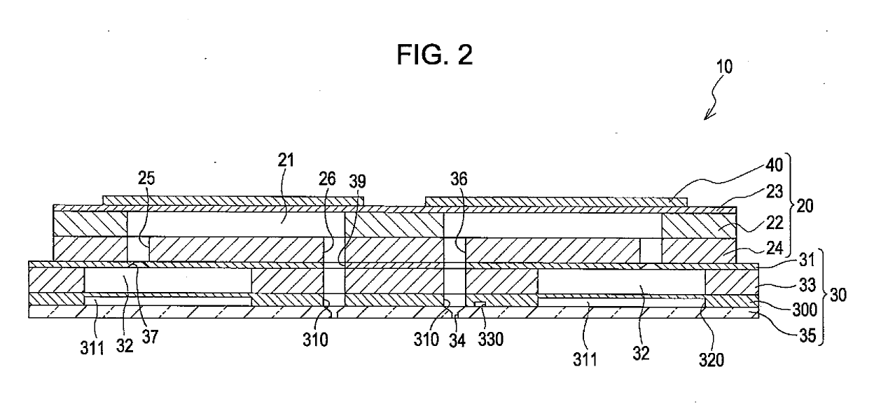

First, a head main body (liquid ejecting head) 10 is described. FIG. 1 is an exploded perspective view of the head main body 10, and FIG. 2 is a cross-sectional view of the head main body 10. As shown in the drawings, the head main body 10 according to the embodiment includes an actuator unit 20, and a flow path unit 30 to which the actuator unit 20 is fixed.

The actuator unit 20 is an actuator apparatus including piezoelectric devices 40, a flow path forming substrate 22 in which pressure generating chambers 21 are formed, a vibration plate 23 provided on one face of the flow path forming substrate 22 and a pressure generating chamber bottom plate 24 provided on the other face of the flow path forming substrate 22.

According to the embodiment, two rows of pressure generating chambers 21 are formed in the flow path forming substrate 22. Each row includes a plurality of pressure generating chambers 21 and the two rows are arranged in parallel in the width direction of the flow path forming substrate 22. The vibration plate 23 is fixed to one face of the flow path forming substrate 22 and one face of the pressure generating chambers 21 is sealed with the vibration plate 23.

The pressure generating chamber bottom plate 24 is fixed to the other face of the flow path forming substrate 22 and seals the other face of the pressure generating chambers 21. The pressure generating chamber bottom plate 24 has supply communicating holes 25 which are provided in the vicinity of one end in the longitudinal direction of the pressure generating chambers 21 and communicates with the pressure generating chambers 21 and reservoirs which will be described later, and nozzle communicating holes 26 which are provided in the vicinity of the other end in the longitudinal direction of the pressure generating chambers 21 and communicate with nozzle openings 34 which will be described later.

The piezoelectric devices 40 are provided on the vibration plate 23 at regions where each piezoelectric device 40 is opposed to the corresponding pressure generating chamber 21. For example, since two rows of the pressure generating chambers 21 are provided in the embodiment, two rows of the piezoelectric devices 40 are also provided.

Each piezoelectric device 40 includes a lower electrode film provided on the vibration plate 23, a piezoelectric layer independently provided for each pressure generating chamber 21, and an upper electrode film provided on each piezoelectric layer. The piezoelectric layer is formed by green sheet coating or printing, for example. The lower electrode film is provided over the piezoelectric layer provided in parallel so as to be a common electrode of each piezoelectric device 40 and functions as a part of the vibration plate 23. It is needless to say that the lower electrode film may be provided on every piezoelectric layer.

The flow path forming substrate 22, the vibration plate 23 and the pressure generating chamber bottom plate 24 each of which is a layer of the actuator unit 20 are integrated without adhesive by forming clay ceramic materials into predetermined thicknesses, making holes as the pressure generating chambers 21 through the material, for example, and then stacking and baking the materials. Thereafter, the piezoelectric devices 40 are formed on the vibration plate 23.

The flow path unit 30 includes an ink supply port forming substrate 31 which is bonded with adhesive to the pressure generating chamber bottom plate 24 of the actuator unit 20, a reservoir forming substrate 33 in which reservoirs 32 to be common ink chambers for the plurality of pressure generating chambers 21 are formed, a compliance substrate 300 bonded to the reservoir forming substrate 33 and a nozzle plate 35 in which nozzle openings 34 are formed.

The ink supply port forming substrate 31 has nozzle communicating holes 36 connecting the nozzle openings 34 and the pressure generating chambers 21, ink supply ports 37 connecting the reservoirs 32 and the pressure generating chambers 21 along with the above supply communicating holes 25, and ink introducing ports 38 communicating with respective reservoirs 32 and connecting to the above ink supply path.

The reservoir forming substrate 33 has the reservoirs 32 and nozzle communicating holes 39 which communicate the pressure generating chambers 21 with the nozzle openings 34. The reservoirs 32 receiving inks supplied from an ink cartridge (not shown) are made of a corrosion-resistant plate material such as a stainless steel, which is appropriate for constituting the ink flow path, and supply the inks to the pressure generating chambers 21.

The compliance substrate 300 (communicating path forming substrate) has nozzle communicating holes 310 at the center in the width direction, which communicate the pressure generating chambers 21 with the nozzle openings 34. The compliance substrate 300 is bonded to the reservoir forming substrate 33 on the side opposite to the flow path forming substrate 22 side so as to seal the opposite side of the reservoirs 32.

Spaces are formed in the compliance substrate 300 on the side of the nozzle plate 35 at the regions corresponding to the reservoirs 32. The spaces function as compliance portions 320.

The nozzle plate 35 is made of a member having a transparent property. The member having the transparent property includes glass or synthetic resins such as polyimide. It is sufficient that the nozzle plate 35 has a transparent property at least to the extent that the mark to be described below can be recognized from the nozzle plate 35 side. The nozzle plate 35 may be so-called translucent. The nozzle plate 35 having the transparent property has the nozzle openings 34 formed by making holes at the same arrangement pitch as the pressure generating chambers 21. In an embodiment, for example, the flow path unit 30 has two rows of the pressure generating chambers 21, and the nozzle plate 35 has two rows of nozzle openings 34.

The flow path unit 30 as described above is formed by fixing the ink supply port forming substrate 31, the reservoir forming substrate 33, the compliance substrate 300 and the nozzle plate 35 to each other with an adhesive, a heat adhesion film, or the like. In addition, the flow path unit 30 and the actuator unit 20 are bonded and fixed to each other with adhesive or heat adhesion film.

The head main body 10 including the actuator unit 20 and the flow path unit 30 has the ink introducing ports 38, the reservoirs 32, the ink supply ports 37, the supply communicating holes 25, the pressure generating chambers 21, the nozzle communicating holes 26, 36, 39, and the nozzle openings 34, as ink flow paths (communicating paths).

When a plurality of such head main bodies 10 are aligned, the nozzle openings 34, in particular, the nozzle openings 34 actually discharging liquid droplets are preferably used in order to improve the positioning accuracy. This is because the nozzle opening 34 actually discharging liquid droplets is formed with high accuracy. Further, the nozzle openings 34 other than those at both ends of the nozzle row are preferably used as references for positioning because errors can be increased if the nozzle openings 34 at both ends of the nozzle row are set to be references for positioning for the following reasons. The reasons are that nozzle openings 34 at both ends of the nozzle row may be dummy nozzles which discharge no inks or the opening positions thereof may be deviated since the surface of the substrate moves over after making holes as nozzle openings through the substrate. However, nozzle openings 34 other than those at both ends of the nozzle row have not been set as references for positioning since it is difficult to specify the distance from an end to a nozzle opening when the head main bodies are aligned by using optical systems such as a microscope.

In the embodiment, a recess 330 is formed on a surface of the compliance substrate 300 bonded to the nozzle plate 35. The recess 330 is set as a mark for identifying the nozzle opening 34 as a reference for positioning when the head main body 10 is aligned. In this case, since the nozzle plate 35 has the transparent property, the recess 330 (mark) can be recognized from the nozzle plate 35 side even though the recess 330 is formed on the compliance substrate. In the embodiment, any nozzle openings 34 can be set as a reference for positioning without limiting to the nozzle openings 34 at both ends of the nozzle row by forming such mark. The recess 330 for identifying the nozzle opening which can be used as a reference for positioning is formed on a surface of the compliance substrate 300 bonded to the nozzle plate 35, not on the surface of the nozzle plate 35. Therefore, when the surface of the nozzle plate is wiped, inks are not kneaded into the recess so that an ink-discharging surface is not contaminated.

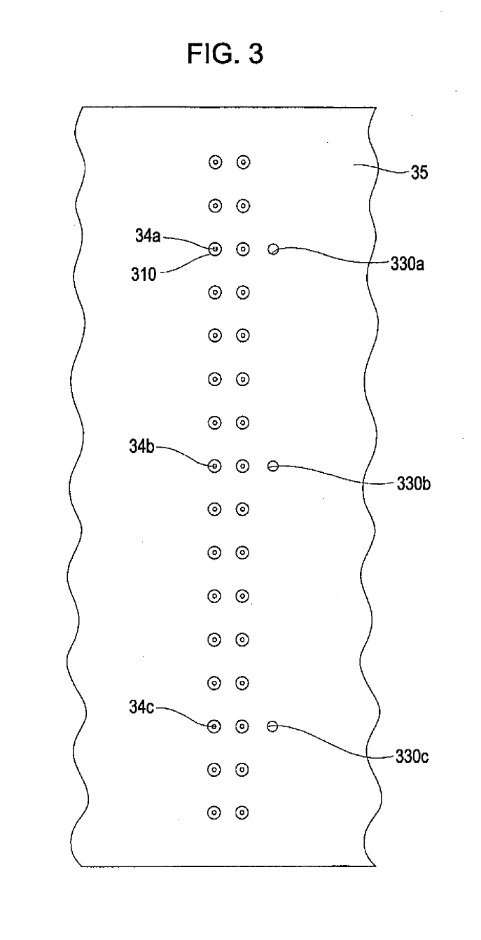

Such recess 330 is described in detail with reference to FIG. 3. FIG. 3 is a schematic bottom view (a view seen from the nozzle plate side) of the head main body 10 according to the embodiment. Since the nozzle plate 35 is transparent as described above, the nozzle openings 34 as well as the nozzle communicating holes 310 and the recess 330 formed on the compliance substrate 300 can be recognized from the bottom of the nozzle plate 35. For example, three marks 330a, 330b, 330c are formed as marks being the recess 330 on the compliance substrate 300. The mark 330a corresponds to a nozzle opening 34a which is a third nozzle opening from one end (upper side in the drawing) of the nozzle row, and the mark 330b corresponds to a nozzle opening 34b which is an eighth nozzle opening therefrom. The mark 330c corresponds to a nozzle opening 34c which is a third nozzle opening from the other end (lower side in the drawing) of the nozzle row. As described above, nozzle openings other than those at both ends of the nozzle row can be set as a reference for positioning in the embodiment. The number of nozzle openings 34 as references for positioning can be defined appropriately. However, if at least three nozzle openings are defined as references for positioning as in the embodiment, the head main body 10 can be aligned with high accuracy. In this case, these nozzle openings 34a, 34b, 34c are preferably provided at both end sides and center of the nozzle row. This allows the head main body 10 to be aligned with high accuracy.

Although the marks 330a, 330b, 330c are circular shapes when seen from the nozzle plate 35 side as shown in FIG. 3, the shapes thereof are not particularly limited thereto. That is, the marks may be rectangular or linear in shape, or represent numbers or the like as long as the marks can be recognized from the nozzle plate 35 side.

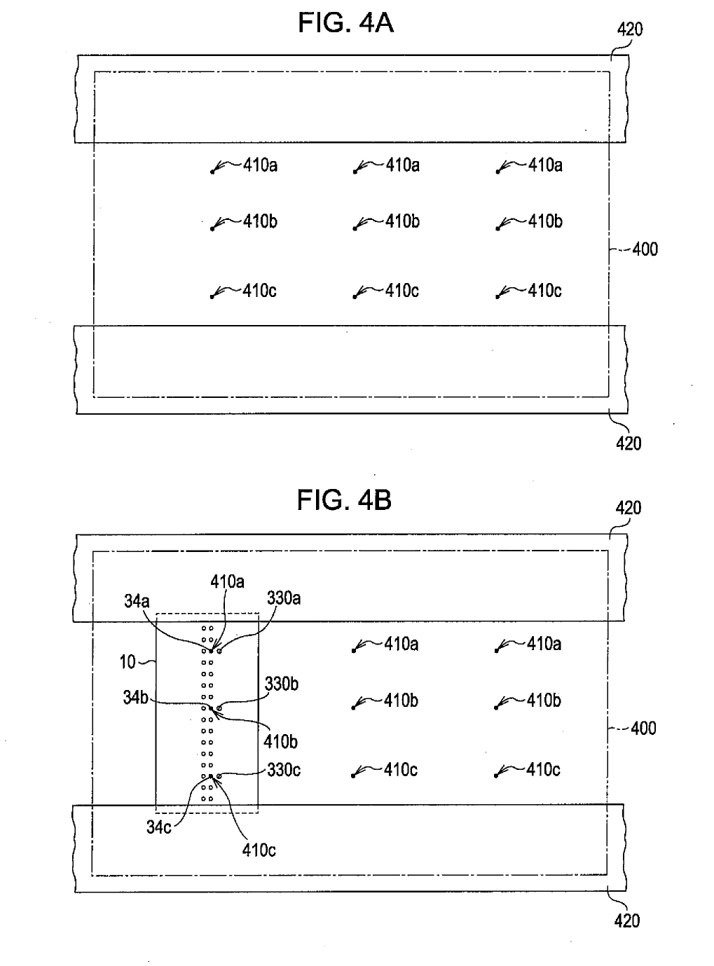

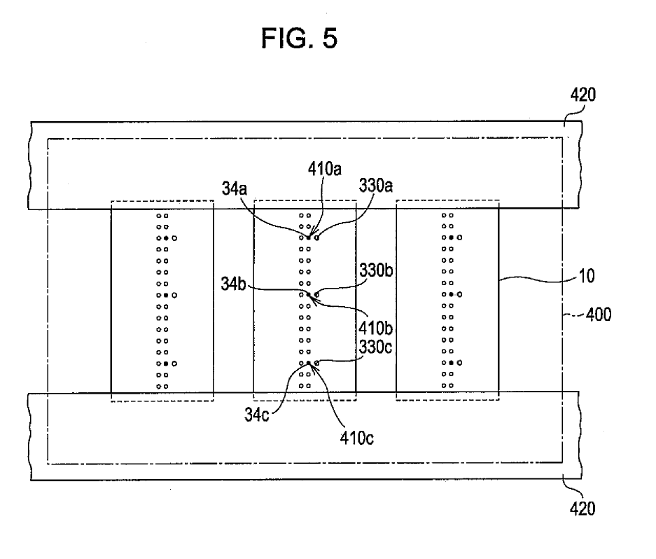

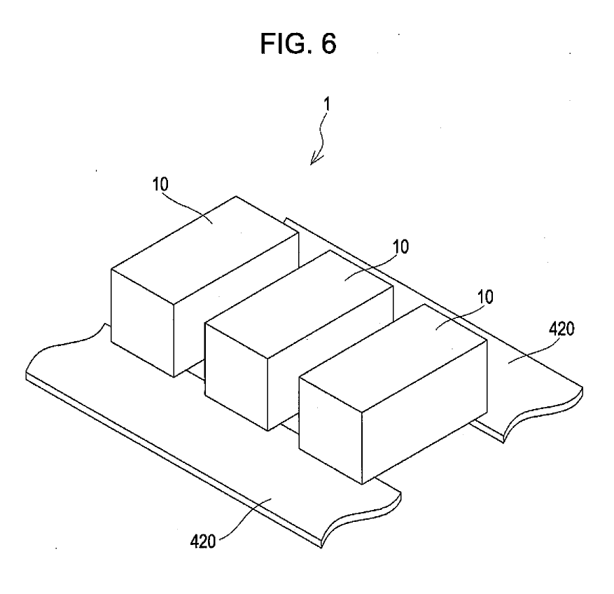

A method of aligning a plurality of the head main bodies 10 included in an ink jet recording head unit is described with reference to FIGS. 4 to 6. FIGS. 4 and 5 are schematic views illustrating the alignment method, and FIG. 6 is a schematic perspective view showing the ink jet recording head unit 1.

First, a transparent base substrate 400 is placed. The base substrate 400 is provided with alignment marks 410a, 410b, 410c. The alignment mark 410a corresponds to the nozzle opening 34a as a reference for positioning which is identified by the mark 330a. Similarly, the alignment mark 410b corresponds to the nozzle opening 34b as a reference for positioning which is identified by the mark 330b, and the alignment mark 410c corresponds to the nozzle opening 34c as a reference for positioning which is identified by the mark 330c.

A pair of fixing members 420 are placed on one face of the base substrate 400. The head main bodies 10 positioned with high accuracy by alignment to be described below are fixed to the pair of fixing members 420. Specifically, the head main bodies 10 are placed on one face of the base substrate 400 on which the fixing members 420 are fixed. Each of the head main bodies 10 is aligned while whether the nozzle openings 34a, 34b, 34c as references for positioning identified by the marks 330a, 330b, 330c match the corresponding alignment marks 410a, 410b, 410c, respectively, are observed with optical systems such as a CCD camera or a microscope through the nozzle plate 35 from the base substrate 400 side. In this case, positioning of each head main body 10 can be finely adjusted by a micrometer (not shown), for example. The nozzle openings 34a, 34b, 34c as references for positioning may be automatically positioned with the corresponding alignment marks 410a, 410b, 410c, respectively by processing an image taken by a CCD camera as an optical system and driving a micrometer by a driving motor or the like, as a matter of course. Thus, each head main body 10 (three bodies in the drawing, for example) is aligned as shown in FIG. 5.

Thereafter, the aligned head main bodies 10 are fixed to the fixing members 420 with adhesive, for example as shown in FIG. 6. Each of the head main bodies 10 is accommodated in a cover member (not shown) to constitute the ink jet recording head unit 1 as an example of a liquid ejecting head. Such ink jet recording head unit 1 has high reliability in an ink-discharging property since the head main bodies 10 are aligned with high accuracy.

The ink jet recording head unit 1 according to the embodiment is accommodated in a cover (not shown). Inks are introduced from ink cartridges provided within the cover to fill the ink jet recording head unit 1 from the reservoirs 32 to the nozzle openings 34 with inks. Thereafter, the voltage is applied between the lower electrode film and the upper electrode film which correspond to each pressure generating chamber 21 and the piezoelectric layer and the vibration plate 23 are flexurally deformed. Therefore, the pressure in each pressure generating chamber 21 increases, so that the ink droplets are discharged from each nozzle opening 34.

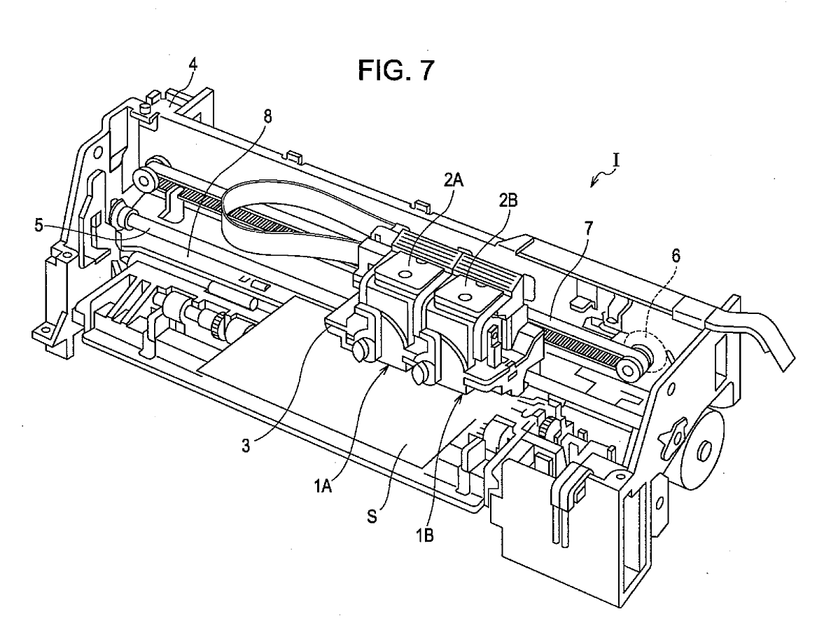

FIG. 7 is a schematic perspective view showing the ink jet recording apparatus as an example of a liquid ejecting apparatus according to the embodiment. As shown in FIG. 7, the ink jet recording head units 1 as examples of liquid ejecting head units are provided on the ink jet recording apparatus I as an example of a liquid ejecting apparatus. Ink cartridges 2A, 2B are provided on the ink jet recording head units 1A, 1B in a detachable manner, respectively. The ink jet recording head units 1 are mounted to a carriage 3.

The carriage 3 to which the ink jet recording head units 1 are mounted is provided on a carriage axis 5 attached to an apparatus main body 4 movably in the axial direction. The carriage 3 to which the ink jet recording head units 1 are mounted is moved along the carriage axis 5 by transmitting the driving power of a driving motor 6 to the carriage 3 through a plurality of gears (not shown) and a timing belt 7. Meanwhile, a platen 8 is provided on the apparatus main body 4 along the carriage axis 5 so that a recording sheet S which is a recording medium such as a paper fed by a feeding roller (not shown) or the like is transported on the platen 8.

### Other Embodiments

Although the embodiment of the invention has been described above, basic configuration of the invention is not limited to the above configuration. The recess 330 is formed on the compliance substrate 300 in the embodiment. However, the recess 330 may be formed on any substrates as long as the substrate (communicating path forming substrate) is bonded to the nozzle plate 35 and has the communicating path (liquid path flow) which communicates to the nozzle openings 34. For example, if the compliance substrate 300 is not provided, the recess 330 may be provided on the reservoir forming substrate 33 as long as the reservoir forming substrate 33 is bonded to the nozzle plate 35. Further, the recess 330 may be formed on a surface of the nozzle plate 35 bonded to the compliance substrate 300. Since the recess 330 can be checked from the nozzle plate 35 side with this configuration, alignment can be easily performed with high accuracy. In addition, the recess 330 is not formed on a discharging surface of the nozzle plate 35 so that the ink-discharging surface is not contaminated.

Further, the invention can be applied to a liquid ejecting head having a transparent nozzle plate 35 even though the liquid ejecting head is not the head main body 10 according to the embodiment. For example, the head main body 10 according to the embodiment is an ink jet recording head including so-called thick film type piezoelectric devices, in which each layer is formed by green sheet coating or printing. However, alignment can be easily performed by providing the recess 330 on a surface of one of the nozzle plate and a substrate bonded to a surface of the other as long as the nozzle plate having the nozzle formed is transparent even though the head main body 10 is an ink jet recording head including so-called thin film piezoelectric devices, in which each layer is formed by film formation and a lithography method.

In the above embodiment, the ink jet recording head unit has been described as an example of the liquid ejecting head unit according to the invention. However, basic configuration of the liquid ejecting head unit is not limited thereto. The invention is widely directed to the liquid ejecting head unit in general. As a matter of course, the invention can be applied to a liquid ejecting head unit ejecting liquids other than ink. Examples of other liquid ejecting head units include various types of recording head units used for the image recording apparatus such as a printer, a color material ejecting head unit used for manufacturing a color filter used for a liquid crystal display or the like, an electrode material ejecting head unit used for forming an electrode of an organic EL display, an FED (a field emission display) or the like, and a bio-organic substance ejecting head unit used for manufacturing a bio-chip.

What is claimed is:

1. A liquid ejecting head comprising:
a nozzle plate that has a transparent property and includes a nozzle row in which a plurality of nozzle openings ejecting liquids are arranged in line; and
a communicating path forming substrate that is bonded to the nozzle plate and has a communicating path communicating with the nozzle openings,
wherein on a surface of one of the communicating path forming substrate and the nozzle plate bonded to a surface of the other thereof, a mark for identifying a nozzle opening as a reference for positioning is formed in the vicinity of the nozzle opening as a reference for positioning among the nozzle openings.

2. The liquid ejecting head according to claim 1,
wherein the mark is a recess formed on the surface of the communicating path forming substrate bonded to the surface of the nozzle plate.

3. A liquid ejecting head unit comprising:
a plurality of the liquid ejecting heads according to claim 1; and
a fixing member that positions and fixes the liquid ejecting heads with reference to the nozzle opening as a reference for positioning identified by the mark from the nozzle plate side.

4. A liquid ejecting apparatus comprising the liquid ejecting head unit according to claim 3.
